(19) United States
(12) Patent Application Publication
(10) Pub. No.: US 2022/0017025 A1
(43) Pub. Date: Jan. 20, 2022

(54) WIRE HARNESS FIXING STRUCTURE

(71) Applicants: SUMITOMO ELECTRIC INDUSTRIES, LTD., Osaka (JP); AUTONETWORKS TECHNOLOGIES, LTD., Mie (JP); SUMITOMO WIRING SYSTEMS, LTD., Mie (JP)

(72) Inventors: Sofia BARILLARO, Osaka (JP); Toru TANJI, Osaka (JP); Yasushi NOMURA, Osaka (JP); Hiroki HIRAI, Mie (JP); Makoto HIGASHIKOZONO, Mie (JP); Housei MIZUNO, Mie (JP); Koichiro GOTO, Mie (JP)

(73) Assignees: SUMITOMO ELECTRIC INDUSTRIES, LTD., Osaka (JP); AUTONETWORKS TECHNOLOGIES, LTD., Mie (JP); SUMITOMO WIRING SYSTEMS, LTD., Mie (JP)

(21) Appl. No.: 17/275,018

(22) PCT Filed: Mar. 18, 2019
(86) PCT No.: PCT/JP2019/011094

§ 371 Date: Mar. 10, 2021

(30) Foreign Application Priority Data
Sep. 28, 2018 (JP) 2018-184719

(51) Int. Cl. B60R 16/02; H01B 7/40

(52) U.S. Cl. CPC B60R 16/0215; H01B 7/40

(57) ABSTRACT

A wire harness includes: an electric wire including a wire-like conductor and an insulating layer covering the conductor; and a heat dissipation portion for fixing the electric wire to a metal member.

### TECHNICAL FIELD

The present invention relates to a wire harness.

This application claims priority based on Japanese application No. 2018-184719 filed on Sep. 28, 2018, and incorporates all the contents described in the Japanese application.

### BACKGROUND ART

In recent trends of vehicles, next-generation vehicles must meet the demands of a high level of safety and comfort while being fun and attractive. However, making a highly efficient vehicle from a technical viewpoint has mainly hindered the consideration of a more comfortable vehicle interior space, due to an increased space occupied by an electrical device and a wire harness.

In the wire harness, all electric wires are usually collected in a shape as compact as possible by taping or a protective material (protective sheet) in order to reduce the influence of a surrounding environment and vibration (see, for example, Patent Document 1). Such a wire harness is fixed to a mounted portion of a vehicle body by, for example, a clip member or a band clip member (see, for example, Patent Document 2).

### PRIOR ART DOCUMENTS

### Patent Documents

Patent Document 1: Japanese Patent Application Laid-Open No. 2015-072798
Patent Document 2: Japanese Patent Application Laid-Open No. 2016-34230

### SUMMARY

### Problem to be Solved by the Invention

The wire harness is designed to occupy a smallest possible space when disposed or mounted on the vehicle body, but the wire harness is still bulky due to its length and shape, and fixed to the mounted portion of the vehicle body via the clip member or the like, which causes a limit to space saving. Considering that the temperature rise of the electric wire due to current supply is kept within a certain range, it is difficult to reduce the size (cross-sectional area) of the current electric wire.

The present invention has been made in view of such circumstances, and an object of the present invention is to provide a wire harness capable of achieving space saving.

### Means to Solve the Problem

A wire harness according to one aspect of the present invention includes: an electric wire including a wire-like conductor and an insulating layer covering the conductor; and a heat dissipation portion for fixing the electric wire to a metal member.

### Effects of the Invention

The above invention can achieve space saving.

### BRIEF DESCRIPTION OF DRAWINGS

FIG. 1 is a cross-sectional explanatory view of one embodiment of a wire harness of the present invention.

FIG. 2 is a cross-sectional explanatory view of another embodiment of the wire harness of the present invention.

FIG. 3 is a plane explanatory view showing a disposing example of the wire harness of the present invention.

FIG. 4 is a plane explanatory view showing the disposing example of the wire harness of the present invention.

FIG. 5 is a cross-sectional explanatory view of yet another embodiment of the wire harness of the present invention.

FIG. 6 is a cross-sectional explanatory view of another embodiment of the wire harness of the present invention.

FIG. 7 is a cross-sectional explanatory view of yet another embodiment of the wire harness of the present invention.

### DESCRIPTION OF EMBODIMENTS

### Description of Embodiments of the Present Invention

First, embodiments of the present invention will be listed and described.

A wire harness according to one aspect of the present invention includes:

(1) an electric wire including a wire-like conductor and an insulating layer covering the conductor; and a heat dissipation portion for fixing the electric wire to a metal member.

In the wire harness according to the present embodiment, the electric wire composed of the conductor covered with the insulating layer is fixed to the metal member by the heat dissipation portion. Thereby, heat generated by a current flowing through the conductor is transferred to the metal member such as a door trim, a reinforcing bar, or a roofing material, which is a part of a vehicle body, through the heat dissipation portion. In other words, by bringing the electric wire and the metal member of the vehicle body into contact with each other via the heat dissipation portion, the heat generated by current supply can be dispersed in the metal member. As a result, the cross-sectional area of the conductor specified from the viewpoint of keeping the temperature rise of the electric wire due to current supply within a certain range can be made smaller than that of a conventional conductor. Since the electric wire is fixed to the metal member which is a part of the vehicle body via the heat dissipation portion without using a conventional auxiliary tool such as a grip member, the occupied space of the wire harness inside the vehicle body can be reduced.

(2) In the wire harness of the above (1), the heat dissipation portion may include a band body continuously or discontinuously provided along an axial direction of the electric wire. When the heat dissipation portion includes the band body continuously provided along the axial direction of the electric wire, the heat generated by passing an electric current through the conductor can be efficiently dispersed in the metal member. When the heat dissipation portion includes the band body discontinuously provided along the axial direction of the electric wire, a part of the electric wire is an unrestrained portion which is not fixed to the metal member via the heat dissipation portion, which makes it possible to suppress the damage of the electric wire caused by repeated stress acting on the electric wire due to a difference in thermal expansion between the electric wire and the metal member.

(3) In the wire harness of the above (1) or (2), the heat dissipation portion may contain a hot melt adhesive. In this case, the electric wire can be easily fixed to the metal member of the vehicle body by the hot melt adhesive.

(4) In the wire harness of the above (3), the hot melt adhesive may be a polyester-based adhesive. In this case, the electric wire can be easily fixed to the metal member of the vehicle body by the polyester-based adhesive.

(5) In the wire harness of the above (3) or (4), the hot melt adhesive desirably contains a thermally conductive filler. In this case, the electric wire is fixed to the metal member of the vehicle body by the hot melt adhesive containing the thermally conductive filler, whereby the heat generated by current supply can be efficiently dispersed in the metal member.

(6) In the wire harness of the above (1), the heat dissipation portion may be a rivet. In this case, the heat generated by passing an electric current through the electric wire can be dispersed in the metal member of the vehicle body via the metal rivet.

(7) In the wire harness of the above (1) or (2), the heat dissipation portion may be an ultrasonic weldment portion. In this case, the electric wire can be fixed to the metal member by ultrasonically welding the electric wire to the metal member.

(8) In the wire harness of the above (1) or (2), the heat dissipation portion may contain a pressure-sensitive adhesive. In this case, the electric wire can be easily fixed to the metal member of the vehicle body by the pressure-sensitive adhesive.

(9) In the wire harness of the above (8), the pressure-sensitive adhesive desirably contains a thermally conductive filler. In this case, the electric wire is fixed to the metal member of the vehicle body by the pressure-sensitive adhesive containing the thermally conductive filler, whereby the heat generated by current supply can be efficiently dispersed in the metal member.

(10) In the wire harnesses of the above (1) to (9), the conductor may have a cross-sectional area smaller than that of a conductor of an electric wire estimated by using formula specified in JASO D609 based on an allowable current of the electric wire. In this case, by reducing the cross-sectional area of the conductor, the occupied space of the wire harness including the conductor can be made smaller than that of a conventional wire harness.

### Details of Embodiments of the Present Invention

Hereinafter, a wire harness of the present invention will be described in detail. The present invention is indicated by the scope of claims without being limited to these examples, and is intended to include all modifications within the meaning and scope equivalent to the scope of claims.

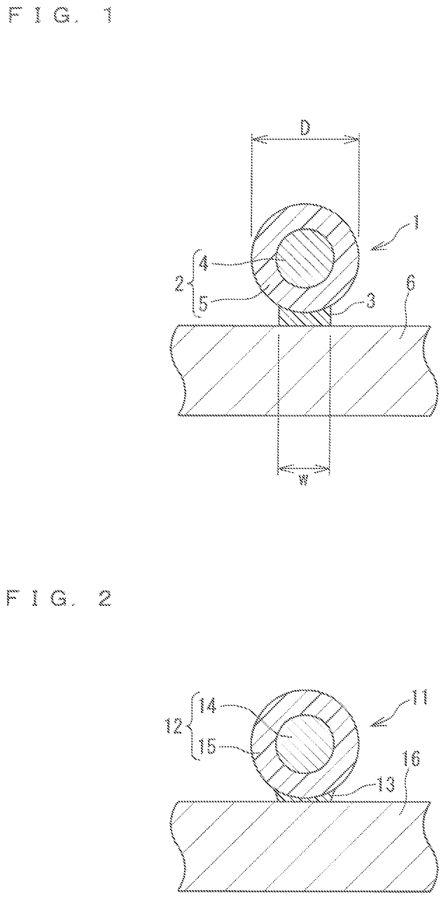

FIG. 1 is a cross-sectional explanatory view of a wire harness 1 according to an embodiment of the present invention. The wire harness 1 includes an electric wire 2 and a hot melt adhesive layer 3 as a heat dissipation portion. The electric wire 2 includes a wire-like conductor 4 having a circular cross section and an insulating layer 5 covering the conductor 4.

The conductor 4 is made of a metal such as copper, iron, or aluminum, and is used for communication or power supply. The insulating layer 5 can be made of a synthetic resin such as polyvinyl chloride (PVC), polyethylene, or polypropylene, or synthetic rubber, or the like.

The hot melt adhesive layer 3 is directly provided on the surface of a metal member 6 such as a door trim, a reinforcing bar, or a roofing material as a part of a vehicle body, on which the wire harness 1 is disposed or fixed. In other words, the hot melt adhesive layer 3 is in direct contact with the surface of the metal member 6. As a hot melt adhesive constituting the hot melt adhesive layer 3, for example, a polyester-based adhesive or an olefin-based adhesive can be used. Of these, it is desirable to use the polyester-based adhesive as the hot melt adhesive from the viewpoint of suppressing deterioration due to a plasticizer in the insulating layer. The electric wire 2 is fixed to the metal member 6 by the hot melt adhesive layer 3 provided on the surface of the metal member 6.

The electric wire 2 is fixed to the metal member 6 by the hot melt adhesive layer 3 directly provided on the metal member 6, whereby heat generated by a current flowing through the conductor 4 is transmitted to the metal member 6 through the hot melt adhesive layer 3. In other words, the heat generated in the conductor 4 by current supply can be dispersed in the metal member 6 via the hot melt adhesive layer 3. As a result, the cross-sectional area of the conductor 4 specified from the viewpoint of keeping the temperature rise due to current supply within a certain range can be made smaller than that of a conventional conductor. That is, the electric wire 2 is made thinner than a conventional electric wire, whereby the space occupied by the wire harness 1 can be reduced.

The allowable current of the conductor 4 of the electric wire 2 can be calculated by using the following formula (1) specified in JASO D609.

I²r=(T₁−T₂)/R (1)

In the formula (1), I is an allowable current; r is conductor resistance; T₁ is a conductor temperature limit point; T₂ is an ambient temperature; and R is thermal resistance. R=R₁+R₂ is set; R₁ is the thermal resistance of the insulator; and R₂ is surface thermal resistance, which can be calculated according to the following formulae (2) and (3).

R₁=(P₁/2π)ln(d₂/d₁) (2)

R₂=10P₂/πd₂ (3)

In the formula (2), P₁ is the intrinsic thermal resistance of the insulator, and P₁=600° C./W/cm³ is set in the case of polyvinyl chloride, for example, d₁ is the outer diameter of the conductor, and d₂ is the outer diameter of the insulator.

In the formula (3), P₂ is the intrinsic surface thermal resistance of the electric wire. When d₂≤12.5 mm is set, P₂ is 300+32d2, and when d₂>12.5 mm is set, P₂=700 is set.

If the ambient temperature T₂ is set to, for example, 40° C., and the thickness of the insulating layer {(d2−d1)/2}, the current value flowing through the conductor, and the conductor temperature limit point which is a temperature capable of being withstood by the conductor are appropriately set, r, P₁, and P₂ are constants determined by the material of the conductor, and the like, whereby the outer diameter d₁ of the conductor required at that time can be estimated. In the wire harness 1 according to the present embodiment, the electric wire 2 is fixed to the metal member 6 by the hot melt adhesive layer 3 as the heat dissipation portion provided in direct contact with the metal member 6 of the vehicle body, whereby the heat generated in the electric wire 2 during current supply can be dispersed in the metal member 6. In other words, when the current value is the same, the conductor temperature limit point or less can be set even if the outer diameter of the conductor 2 is made smaller than that of a conventional conductor.

The hot melt adhesive layer 3 as the heat dissipation portion is provided in a band-like shape along the electric wire 2, and a width w thereof may be, for example, 1D to 10D, and preferably 1D to 3D with respect to an outer diameter D of the insulating layer 5.

It is desirable that the hot melt adhesive constituting the hot melt adhesive layer 3 contains a thermally conductive filler made of alumina or boron nitride or the like in order to improve the thermal conductivity. As a result, the heat generated by the electric wire during current supply can be efficiently transferred to the metal member 6, and dispersed in the metal member 6.

Instead of the hot melt adhesive, a pressure-sensitive adhesive such as a butyl tape or an acrylic foam may also be used. In this case, the pressure-sensitive adhesive layer containing the pressure-sensitive adhesive functions as the heat dissipation portion for fixing the electric wire 2 to the metal member 6. It is desirable that the pressure-sensitive adhesive contains the above-described thermally conductive filler as in the case of the hot melt adhesive. A UV curable adhesive may also be used instead of the hot melt adhesive.

FIG. 2 is a cross-sectional explanatory view of a wire harness 11 according to another embodiment of the present invention. The difference between the wire harness 11 according to the present embodiment and the wire harness 1 shown in FIG. 1 is that the hot melt adhesive layer 3 is used as the heat dissipation portion in the wire harness 1 shown in FIG. 1, whereas an ultrasonic weldment portion 13 obtained by applying ultrasonic waves to an electric wire 12 is used as a heat dissipation portion in the present embodiment. That is, in the present embodiment, instead of fixing the electric wire 2 to the metal member 6 by using a member different from the electric wire 2 such as the hot melt adhesive layer 3, ultrasonic waves are applied to an insulating layer 15 constituting the electric wire 12 to melt a part of the insulating layer 15, and the melted portion is attached to a metal member 16 to form the ultrasonic weldment portion 13. In FIG. 2, reference numeral 14 is a wire-like conductor having a circular cross section and covered with the insulating layer 15.

If the electric wire 12 disposed in contact with the metal member 16 thereon is subjected to pressure while being subjected to ultrasonic vibration (for example, vibration having a frequency higher than 20 khz) by an ultrasonic welding machine (not shown), a portion of the electric wire 12 in contact with the metal member 16 is melted, whereby the melted portion welds the electric wire 12 and the metal member 16. The ultrasonic welding makes it possible to achieve bonding between different materials, i.e., the metal member 16 and the insulating layer 15.

Also in the embodiment shown in FIG. 2, the electric wire 12 is fixed to the metal member 16 by the ultrasonic weldment portion 13 directly provided on the metal member 16, whereby heat generated by a current flowing through the conductor 14 is transferred to the metal member 16 through the ultrasonic weldment portion 13. In other words, the heat generated in the conductor 14 by current supply can be dispersed in the metal member 16.

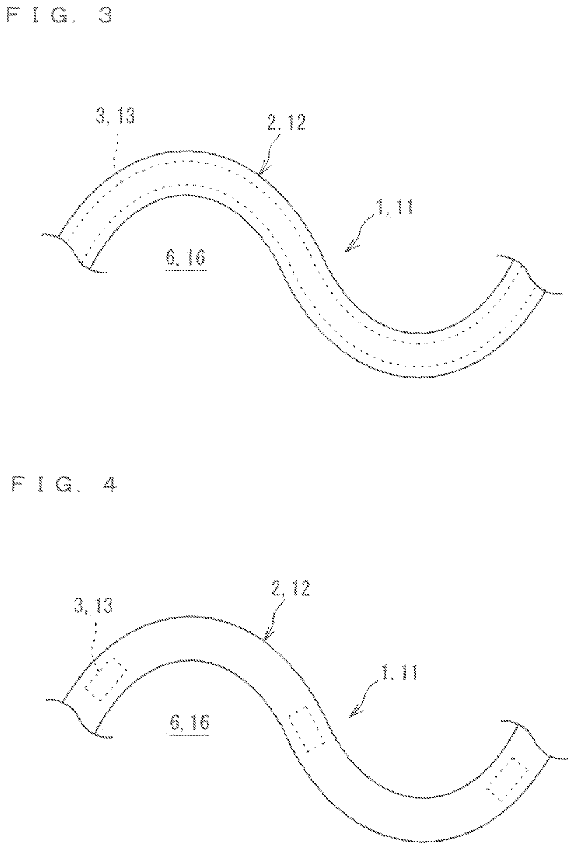

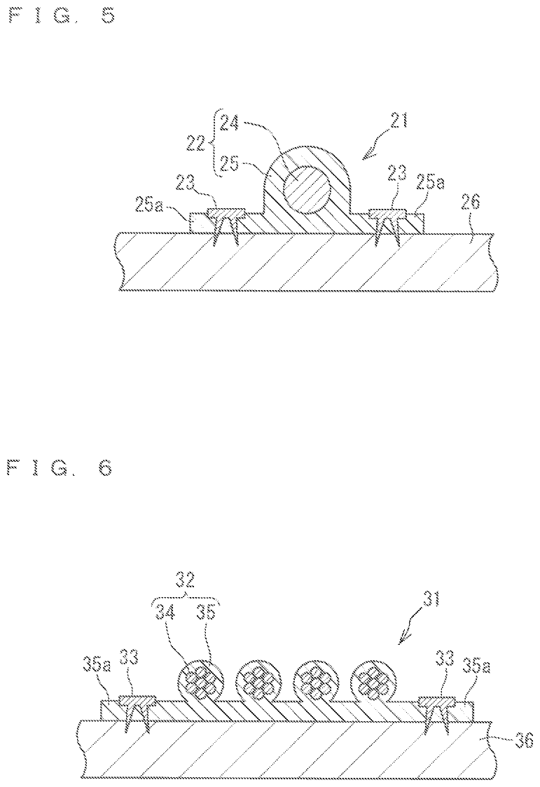

FIGS. 3 and 4 show disposing examples of the wire harnesses 1 and 11 according to the above-described embodiment, and are plan explanatory views seen from a direction orthogonal to the planes of the metal members 6 and 16 to which the wire harnesses 1 and 11 are fixed in a direction orthogonal to the axis of the electric wires 2 and 12 constituting the wire harnesses 1 and 11.

In the example shown in FIG. 3, the hot melt adhesive layer 3 or the ultrasonic weldment portion 13 as the heat dissipation portion includes a band body continuously provided along the axial direction of the electric wires 2 and 12. When the heat dissipation portion is continuously provided in a band-like shape along the axial direction of the electric wires 2 and 12, the heat generated by passing an electric current through the conductors 4 and 14 can be efficiently dispersed in the metal members 6 and 16.

Meanwhile, in the example shown in FIG. 4, the hot melt adhesive layer 3 or the ultrasonic weldment portion 13 as the heat dissipation portion includes a band body discontinuously provided along the axial direction of the electric wires 2 and 12. More specifically, an elongated band-like heat dissipation portion is provided only in the linear portion of the electric wires 2 and 12 disposed in a corrugated shape. The heat dissipation portion is discontinuously provided along the axial direction of the electric wires 2 and 12, and a part of the electric wires 2 and 12 (in the example of FIG. 4, a curved portion of the electric wires 2 and 12) is an unrestrained portion which is not fixed to the metal members 6 and 16 via the heat dissipation portion, whereby stress is repeatedly applied to the electric wires 2 and 12 due to the difference in thermal expansion between the electric wires 2 and 12 and the metal members 6 and 16, which makes it possible to suppress the damage of the electric wire 2 and 12. In the example shown in FIG. 4, an allowance degree of deformation is applied to the electric wires 2 and 12 by forming a curved portion between the adjacent heat dissipation portions, whereby the damage of the electric wires 2 and 12 due to the difference in thermal expansion can be further suppressed. Therefore, in terms of design, for example, when an electric wire is disposed in a state where the electric wire is bent into an L shape, an unconstrained portion including no heat dissipation portion is formed in the front and back of the bent corner portion, whereby the damage of the electric wire due to the difference in thermal expansion can be suppressed.

FIG. 5 is a cross-sectional explanatory view of a wire harness 21 according to yet another embodiment of the present invention. The wire harness 21 includes an electric wire 22 and a rivet 23 as a heat dissipation portion. The electric wire 22 includes a wire-like conductor 24 having a circular cross section and an insulating layer 25 covering the conductor 24.

Unlike the wire harnesses 1 and 11 shown in FIGS. 1 to 4, the wire harness 21 according to the present embodiment is not fixed to the metal members 6 and 16 by adhesion or welding due to the hot melt adhesive layer 3 or the ultrasonic weldment portion 13, but mechanically fixed to a metal member 26 by the rivet 23. As the rivet 23, a blind rivet or the like capable of fixing the electric wire 22 to the metal member 26 from one side of the metal member 26 can be used. The blind rivet makes it necessary to form a hole in the metal member 26 in advance, but the blind rivet can bond members having various thicknesses as compared with a similar technique such as a normal rivet or a self-piercing rivet can be bonded. The type of the rivet to be used can be selected depending on the characteristics and thickness of the metal member and extension portion of the insulating layer to be described later.

When a fixing method due to the rivet 23 is adopted, the insulating layer 25 covering the conductor 24 needs to be provided with an extension portion 25a for engaging with the rivet 23 in addition to a portion provided around the conductor 24. From the viewpoint of securely fixing the electric wire 22 to the metal member 26, the extension portion 25a is desirably provided on each of both sides of the conductor 24 of the electric wire 22 (the right side and left side of the conductor 24 in FIG. 5).

Also in the embodiment shown in FIG. 5, the electric wire 22 is fixed to the metal member 26 by the rivet 23 which is in direct contact with the metal member 26, whereby heat generated by a current flowing through the conductor 24 is transmitted to the metal member 26 through the insulating layer 25 and the rivet 23. In other words, the heat generated in the conductor 24 by current supply can be dispersed in the metal member 26.

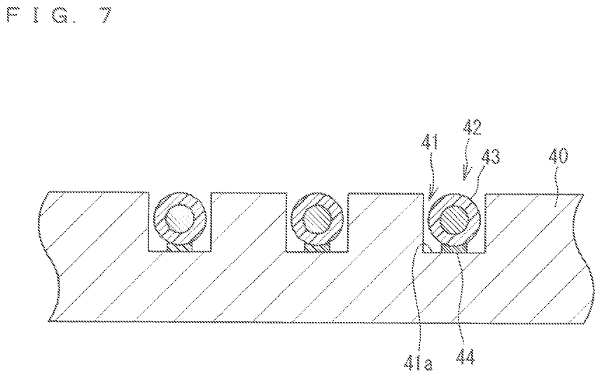

FIG. 6 is a cross-sectional explanatory view of a wire harness 31 according to another embodiment of the present invention. In the present embodiment, a conductor 34 constituting an electric wire 32 includes a stranded wire obtained by twisting a plurality of single wires. A common insulating layer 35 covers four stranded wires disposed side by side. The wire harness 31 is fixed to a metal member 36 by fixing an extension portion 35a of the insulating layer 35 to the metal member 36 by a rivet 33 such as a blind rivet.

Also in the embodiment shown in FIG. 6, the electric wire 32 is fixed to the metal member 36 by the rivet 33 which is in direct contact with the metal member 36, whereby heat generated by a current flowing through the conductor 34 is transmitted to the metal member 36 through the insulating layer 35 and the rivet 33. In other words, the heat generated in the conductor 34 by current supply can be dispersed in the metal member 36.

### EXPERIMENTAL EXAMPLES

Next, Experimental Examples for confirming the heat dissipation property of a wire harness of the present invention will be described.

### Experimental Example 1

Table 1 shows a peel strength and the temperature of an electric wire during current supply when the electric wire is fixed to a metal member (steel) of a vehicle body by ultrasonic welding (Experiment Nos. 1 to 7). For comparison, the temperature of an electric wire during current supply in the case of only the electric wire which is not fixed to a metal member or the like (Experiment Nos. 11 to 13) is shown. The specifications of the electric wire and the conditions for ultrasonic welding are as shown in Table 1. A conductor is made of copper.

TABLE 1

| | | | | | | | | | Temperature |
|---|---|---|---|---|---|---|---|---|---|
| | | Electric wire | | | | | | | of electric |
| | | | Conductor | Bonding condition | | | Peel | | wire during |
| | | Insulating | size | Time | Load | Amplitude | strength | Current | current supply |
| No. | Substrate | material | [mm²] | [s] | [N] | [μm] | [N] | [A] | [° C.] |
| 1 | Steel | PVC | 1.25 | 1 | 30 | 50 | 20 | 18 | 70 |
| 2 | Steel | PVC | 1.25 | 1 | 20 | 50 | 17 | 18 | 72 |
| 3 | Steel | PVC | 1.25 | 1 | 30 | 40 | 11 | 18 | 74 |
| 4 | Steel | PVC | 0.13 | 1 | 30 | 50 | 15 | 3.5 | 69 |
| 5 | Steel | PVC | 0.13 | 1 | 20 | 50 | 10 | 3.5 | 73 |
| 6 | Steel | PVC | 0.13 | 1.5 | 30 | 50 | 16 | 3.5 | 69 |
| 7 | Steel | PVC | 2.0 | 1 | 30 | 50 | 22 | 26 | 71 |
| 11 | None | PVC | 0.13 | — | — | — | — | 3.5 | 80 |
| 12 | None | PVC | 1.25 | — | — | — | — | 18 | 80 |
| 13 | None | PVC | 2.0 | — | — | — | — | 26 | 80 |

From Table 1, it can be seen that, by fixing the electric wire to the metal member by an ultrasonic weldment portion as a heat dissipation portion, the temperature of the electric wire during current supply can be lowered as compared with the case of only the electric wire. It can be seen that the electric wire can be fixed to the metal member with a certain strength by ultrasonic welding.

### Experimental Example 2

Table 2 shows a peel strength and the temperature of an electric wire including a conductor including a stranded wire during current supply when the electric wire is fixed to a metal member of a vehicle body using a rivet as shown in FIG. 6 (Experiment Nos. 8 to 10). For comparison, the temperature of an electric wire during current supply in the case of only the electric wire which is not fixed to the metal member or the like (Experiment Nos. 14 to 16) is shown. The specifications of the electric wire are as shown in Table 2. A conductor is made of copper.

TABLE 2

| | | | | | | Temperature |
|---|---|---|---|---|---|---|
| | | Electric wire | | | | of electric |
| | | | Conductor | Peel | | wire during |
| | Sub- | Insulating | size | strength | Current | current supply |
| No. | strate | material | [mm²] | [N] | [A] | [° C.] |
| 8 | Steel | PVC | 0.13 | 27 | 3.5 | 72 |
| 9 | Steel | PVC | 1.25 | 32 | 18 | 71 |
| 10 | Steel | PVC | 2.0 | 35 | 26 | 71 |
| 14 | None | PVC | 0.13 | — | 3.5 | 80 |
| 15 | None | PVC | 1.25 | — | 18 | 80 |
| 16 | None | PVC | 2.0 | — | 26 | 80 |

From Table 2, it can be seen that, by fixing the electric wire to the metal member by the rivet (blind rivet) as a heat dissipation portion, the temperature of the electric wire during current supply can be lowered as compared with the case of only the electric wire. It can be seen that the electric wire can be fixed to the metal member with a certain strength by the rivet. It can be seen that the fixation of the electric wire using the rivet provides a larger peel strength than that of the fixation due to ultrasonic welding.

The wire harnesses according to the above-described various embodiments are fixed to the metal member of the vehicle body without using a conventional auxiliary tool such as a grip member. The wire harness is not provided separately from the vehicle body in the vehicle interior space, but is provided so as to be in contact with the vehicle body. As described above, the wire harness of the present invention is obtained by converting a conventional three-dimensional shape into a two-dimensional design. As a result, the vehicle interior space can be saved, and the manufacturing automation can be facilitated. In the conventional wire harness, much manual works such as fixing to the vehicle body remain, but the wire harness according to the embodiment in which the electric wire is fixed to the vehicle body by the heat dissipation portion has a simple design, and does not require many steps, which can easily achieve the automation.

Various means such as adhesion, pressure-sensitive adhesion, ultrasonic welding, and rivets can be adopted to fix the electric wire to the vehicle body, whereby means for fixing the electric wire can be appropriately selected depending on various materials constituting the vehicle body such as stainless steel, aluminum, and a magnesium alloy.

According to the above-described embodiment, the size of the electric wire can be reduced by improving the heat dissipation property of the electric wire during current supply, and the use of an auxiliary tool such as a grip member for fixing the wire harness to the vehicle body can be omitted, whereby the weight of the wire harness can be reduced. This makes it possible to reduce the weight of the vehicle, and as a result, the fuel efficiency of the vehicle can be improved.

### Other Variants

The present invention is not limited to the above-described embodiment, and various modifications can be made within the scope of the claims.

For example, in the above-described embodiment, the wire harness is fixed to the flat surface of the metal member, but as shown in FIG. 7, a groove 41 may be formed in the surface of a metal member 40, a wire harness 42 being fixed to a bottom surface 41a of the groove 41. In this case, heat generated in an electric wire 43 of the wire harness 42 during current supply is dispersed in the metal member 40 via a heat dissipation portion 44 such as a hot melt adhesive which fixes the electric wire 43 to the bottom surface 41a of the groove 41. As shown in FIG. 7, one wire harness 42 may be disposed in the groove 41, or the width of the groove 41 may be increased so that a plurality of wire harnesses are disposed side by side on the bottom surface 41a of the groove 41.

In the above-described embodiment, the heat dissipation portion is discontinuously provided in the electric wire disposed in a corrugated shape, but even when the heat dissipation portion is discontinuously provided in the linearly disposed electric wire, the damage of the electric wire caused by the difference in thermal expansion can be suppressed.

In the above-described embodiment, the electric wire is in a bare state, but a metal sheet or a metal mesh made of copper or aluminum or the like may also be attached onto the electric wire. In this case, by attaching the metal sheet or the metal mesh, the heat dissipation property of the heat generated by the electric wire during current supply can be improved. In the case of the metal sheet, noise propagation can also be suppressed.

In the above-described embodiment, the heat dissipation portion such as the hot melt adhesive is directly provided on the surface of the metal member, but in order to improve the adhesion with the electric wire, the surface of the metal member may also be subjected to a surface treatment such as anticorrosion, roughening, or coating. For example, as the coating, the same synthetic resin as that constituting the insulating layer of the electric wire may be coated on the surface of the metal member to which the electric wire is fixed.

### EXPLANATION OF REFERENCE SIGNS

1: wire harness
2: electric wire
3: hot melt adhesive layer
4: conductor
5: insulating layer
6: metal member
11: wire harness
12: electric wire
13: ultrasonic weldment portion
14: conductor
15: insulating layer
16: metal member
21: wire harness
22: electric wire
23: rivet
24: conductor
25: insulating layer
26: metal member
31: wire harness
32: electric wire
33: rivet
34: conductor
35: insulating layer
36: metal member
40: metal member
41: groove
41a: bottom surface
42: wire harness
43: electric wire
44: heat dissipation portion

1. A wire harness fixing structure comprising:
an electric wire including a wire-like conductor and an insulating layer covering the conductor;
a metal member being a art of a vehicle body; and
a heat dissipation portion for fixing the electric wire to the metal member, wherein
the electric wire is bent on the surface of the metal member, and
the heat dissipation portion is a hot melt adhesive, a pressure-sensitive adhesive or a rivet.

2. The wire harness fixing structure according to claim 1, wherein the heat dissipation portion includes a band body continuously or discontinuously provided along an axial direction of the electric wire.

3. The wire harness fixing structure according to claim 1, wherein the heat dissipation portion contains a hot melt adhesive.

4. The wire harness fixing structure according to claim 3, wherein the hot melt adhesive is a polyester-based adhesive.

5. The wire harness fixing structure according to claim 3, wherein the hot melt adhesive contains a thermally conductive filler.

6. The wire harness fixing structure according to claim 1, wherein the heat dissipation portion is a rivet.

7. (canceled)

8. The wire harness fixing structure according to claim 1, wherein the heat dissipation portion contains a pressure-sensitive adhesive.

9. The wire harness fixing structure according to claim 8, wherein the pressure-sensitive adhesive contains a thermally conductive filler.

10. The wire harness fixing structure according to claim 1, wherein the conductor has a cross-sectional area smaller than that of a conductor of an electric wire estimated by using formula specified in JASO D609 based on an allowable current of the electric wire.
